(19) United States
(12) Patent Application Publication
(10) Pub. No.: US 2013/0268680 A1
(43) Pub. Date: Oct. 10, 2013

(54) USER INTERACTION FOR WEB RESOURCES

(71) Applicants: Gabor Marton, Budapest (HU); Gabor Gesztesi, Budapest (HU)

(72) Inventors: Gabor Marton, Budapest (HU); Gabor Gesztesi, Budapest (HU)

(73) Assignee: NOKIA SIEMENS NETWORKS OY, Espoo (FI)

(21) Appl. No.: 13/995,036

(22) PCT Filed: Dec. 17, 2010
(86) PCT No.: PCT/EP10/70112

§ 371 Date: Jun. 17, 2013

(51) Int. Cl. H04L 12/26

(52) U.S. Cl. CPC H04L 43/0876
USPC 709/226; 709/223

(57) ABSTRACT

It is provided an apparatus (AuthProxy), comprising first receiving means for receiving a service request from a first party (resource server); detecting means for detecting a requirement for user interaction in order to comply with said service request; requesting means for requesting said user interaction from a second party (User Interaction Proxy) different from the first party; and second receiving means for receiving said user interaction as a response from said second party.

### FIELD OF THE INVENTION

The present invention relates to apparatuses, a methods, a system, and a computer program product related to web resources. More particularly, the present invention relates to apparatuses, methods, a system, and a computer program product for user interaction when accessing web resources.

### BACKGROUND OF THE INVENTION

More and more Web applications are composed from simpler services operated by different parties. Many of the contributing services are “UI-less” (UI: user interface) services by their nature, i.e. they don't have a user interface as they do not need a direct interaction with the end-user (e.g.: weather information service, media file store, currency exchange converter, search engine). We call such contributing services Web resources. In a general setting, we have a web of services connected to each other, some playing the role of a client, others being resource servers and yet others appearing in both roles.

In the context of this application, the terms “service” and “resource” are used synonymously, except if a differentiation between these two terms is explicitly made. That is, a “resource” according to the present application may be e.g. a service or a resource, and a “service” according to the present application may be e.g. a resource or a service, too.

In a narrower sense, the invention is related to identity management, because the problem statement originates from a related issue called cross-service authorization. Cross-service authorization—also called as Web API authorization—is a process in which a provider service determines if a consumer service is allowed to access some of its resources or operations owned by a user (the resource owner). A provider service exposes resources—e.g. photos uploaded by users—to other services via an API (Application Programming Interface). A consumer service—e.g. a printing service—accesses such a resource via an API.

HTTP (Hypertext Transfer Protocol) is “an application-level protocol for distributed, collaborative, hypermedia information systems. It is used for retrieving inter-linked resources led to the establishment of the World Wide Web”.

HTTP is a request-response protocol where “a requestor sends a request message to a replier system which receives and processes the request, ultimately returning a message in response”.

OAuth is “an open protocol to allow secure API authorization in a simple and standard method from desktop and web applications” (http://oauth.net/), based on HTTP. Provider services require the presence of a valid OAuth token in the resource request (HTTP request). Speaking in terms of OAuth 2.0 terminology, the client (consumer service) first obtains an access grant from the resource owner, then—in exchange of authenticating itself and submitting the access grant—it obtains an access token from an authorization server, and finally—in exchange of submitting the access token—it retrieves the resource from the resource server (see FIG. 1). (In OAuth 2.0, the functions of Resource Owner, Authorization Server and Resource Server are clearly separated, whereas in OAuth 1.0 they are all tied to the Service Provider by means of the three types of token: unauthorized request token, authorized request token and access token.)

An OAuth Proxy is a utility component supporting OAuth clients (consumer services) in accessing resources at OAuth-enabled resource servers (provider services) by hiding the details of the OAuth protocol. All the client has to know is the URL of the resource to be retrieved; the rest is done by the OAuth Proxy residing between the client and the resource server (for more details, see, as an example, the Google OAuth Proxy explained below).

When a service “deep inside” the web of interconnected services “suddenly” requires end-user interaction, a problem arises.

FIG. 2 shows an example of such a situation. A browser requests a map of the present environment from a location tracker (1.). The location tracker requests the location information from a location source via an OAuth Proxy (2., 3.). That is, the location source is configured such that it requires an authentication of the requestor. Since authentication information is not available, the Location Source returns (4.) a 401 Unauthorized response to the OAuth Proxy, because the request (3.) did not contain a valid access token. At this point, the OAuth Proxy needs end-user interaction (has to redirect the user to the Location Source for authorizing the access to their personal data), but it is not in a direct contact with the end-user.

One option is to involve the client service (Location Tracker) and make it return the necessary UI. For this purpose, however, the Location Tracker service must “understand” the situation i.e. the service logic must be prepared for the user interaction case as well, whereas this interaction—between the user and the Location Source—is not a business of the Location Tracker at all.

So a better solution may be one that does not involve the client service.

FIG. 3 shows a more complex example with one more level of indirection or distance between the user and the interacting service. In this case, a web application (“My Desktop”) is inserted between the browser and the location tracker.

The current practice does not provide a generic solution to the problem.

The Google OAuth Proxy (http://code.google.com/intl/hu/apis/gadgets/docs/oauth.html) is a service which—in combination with a client-side software (JavaScript)—supports developers in “writing gadgets that run on iGoogle and access a user's private data from any website that supports the OAuth protocol” and “is designed to make it easier for gadgets to use the OAuth standard”. The sample gadget code (http://gadget-doc-examples.googlecode.com/svn/trunk/opensocial-gadgets/yahoo-presence.xml) provided by Google accesses Yahoo's API and the OAuth-related configuration is a simple as:

<OAuth>

<Service name=“yahoo”>

<Request param_location=“uri-query”

url=“https://api.login.yahoo.com/oauth/v2/get_request_token”
/>

<Access param_location=“uri-query”

url=“https://api.login.yahoo.com/oauth/v2/get_token” />

<Authorization

url=“https://api.login.yahoo.com/oauth/v2/request_auth” />

</Service>

</OAuth>

Accessing the user's status message—i.e. invoking an OAuth-enabled API method—is done by the following function:

var url = getPresenceUrl( );
var params = getDefaultParams( );
gadgets.io.makeRequest(url, function(response) {

makeRequestCallback(fetchStatusDone, response);

}, params);

where the makeRequestCallback function is implemented by the gadget for performing the steps necessary for authorization—i.e. directing the user to the authorization page at the service provider—like for example:

function makeRequestCallback(nextCallback, response) {

if (response.oauthApprovalUrl) {

var onOpen = function( ) {

showOneSection(‘waiting’);

};
var onClose = function( ) {

completeAuthorization( );

};
var popup = new gadgets.oauth.Popup(

response.oauthApprovalUrl,
“width=800,height=600”,
onOpen,
onClose

);
...

}

}

That is, the Google OAuth Proxy relies on its immediate client for handling the user interaction. It cannot cope with the situation shown in FIG. 3.

SiteMinder (http://www.ca.com/us/collateral/product-briefs/na/ca-siteminder.aspx) “enables users to authenticate only once and have access both to web applications protected by CA SiteMinder WAM [Web Access Management] and non-web applications with access controlled by CA SSO [Single Sign-On]”. The solution authenticates the user before they access the protected service. It cannot cope with the situation where the need for the user interaction arises after the service has been invoked.

The captive portal technique (http://en.wikipedia.org/wiki/Captiveportal)—used e.g. for controlling the WiFi access in hotels—“forces an HTTP client on a network to see a special web page (usually for authentication purposes) before using the Internet normally. A captive portal turns a Web browser into an authentication device. This is done by intercepting all packets, regardless of address or port, until the user opens a browser and tries to access the Internet. At that time the browser is redirected to a web page which may require authentication and/or payment, or simply display an acceptable use policy and require the user to agree”. Similarly to the previous two examples, this technique cannot cope with “lately arising” user interaction requests.

WS-Coordination (https://www.ibm.com/deveoperworks/webservices/library/ws-transjta/) “is a coordination framework to enable distributed participants to agree on a universal outcome over their individual activities”. “Essentially this means that when distributed participants (two application servers on different machines for example), that would otherwise be unable to complete in a controlled manner, would be able to use WS-Coordination to group the actions of each participant together, and further manage them by ensuring that they all agree to a singular outcome for all the actions that they have individually performed under this coordination context”.

The basic WS-Coordination flow is illustrated by FIG. 5.

“1. App1 makes a request to the activation service on a Coordinator.

2. The Coordinator begins a new activity and responds to App1 with its CoordinationContext (XML information of the Coordinator).

3. App1 makes a request to the registration service to register to use coordination protocol X.

4. App1 invokes App2 in whatever way it wishes, passing across the CoordinationContext for the Coordinator.

5. App2 makes a request to the registration service (using parameters such as port information found in the CoordinationContext passed by App1) to register to use coordination protocol Y.

6. App2 finishes its work and control returns back to App1, and the activity is called to complete.

7. The Coordinator responds to App1 using protocol X style messages.

8. The Coordinator responds to App2 using protocol Y style messages”.

The relation of WS-Coordination to the present invention is distant: WS-Coordination does not contain the concept of an intercepting proxy at all.

### SUMMARY OF THE INVENTION

It is an object of the present invention to improve the prior art.

According to a first aspect of the invention, there is provided an apparatus, comprising first receiving means for receiving a service request from a first party; detecting means for detecting a requirement for user interaction in order to comply with said service request; requesting means for requesting said user interaction from a second party different from the first party; and second receiving means for receiving said user interaction as a response from said second party.

In the apparatus, said request for user interaction may comprise an information element for provisioning a user interface for executing said user interaction.

The apparatus may further comprise resource requesting means for requesting a second resource from a resource device in order to comply with said service request; and the detecting means may be adapted to detect the requirement for user interaction based on an exception information received from the resource device in response to the request for the resource.

In the apparatus, the user interaction may be requested from a user who has caused the service request received from the first party.

In the apparatus, said request for user interaction may comprise an identification of said service request.

In the apparatus, the requesting means may be adapted to provide, together with said request for said user interaction, a transaction identifier, wherein the transaction identifier is comprised in the service request received from the first party.

The apparatus may further comprise response means for responding to the first party, wherein the response may comprise a trigger for terminating service execution, compliant to the service request, in the first party.

The apparatus may further comprise handle generating means for generating a handle which is related to the service request received from the first party, and wherein the handle is unique in the realm of the apparatus; handle detecting means for detecting if a handle message comprising the handle is received by the apparatus from the second party; and the requesting means may be adapted to request the user interaction if the handle message is detected.

The apparatus may further comprise identifying means for identifying the second party based on the handle message.

In the apparatus, the service request may comprise a first user identification, and the apparatus may further comprise correlating means for correlating a second service request from the first party with the received user interaction based on a second identification comprised in the second service request.

According to a second aspect of the invention, there is provided an apparatus, comprising first receiving processor for receiving a service request from a first party; detecting processor for detecting a requirement for user interaction in order to comply with said service request; requesting processor for requesting said user interaction from a second party different from the first party; and second receiving processor for receiving said user interaction as a response from said second party.

In the apparatus, said request for user interaction may comprise an information element for provisioning a user interface for executing said user interaction.

The apparatus may further comprise resource requesting processor for requesting a second resource from a resource device in order to comply with said service request; and the detecting processor may be adapted to detect the requirement for user interaction based on an exception information received from the resource device in response to the request for the resource.

In the apparatus, the user interaction may be requested from a user who has caused the service request received from the first party.

In the apparatus, said request for user interaction may comprise an identification of said service request.

In the apparatus, the requesting processor may be adapted to provide, together with said request for said user interaction, a transaction identifier, wherein the transaction identifier is comprised in the service request received from the first party.

The apparatus may further comprise response processor for responding to the first party, wherein the response may comprise a trigger for terminating service execution, compliant to the service request, in the first party.

The apparatus may further comprise handle generating processor for generating a handle which is related to the service request received from the first party, and wherein the handle is unique in the realm of the apparatus; handle detecting processor for detecting if a handle message comprising the handle is received by the apparatus from the second party; and the requesting processor may be adapted to request the user interaction if the handle message is detected.

The apparatus may further comprise identifying processor for identifying the second party based on the handle message.

In the apparatus, the service request may comprise a first user identification, and the apparatus may further comprise correlating processor for correlating a second service request from the first party with the received user interaction based on a second identification comprised in the second service request.

According to a third aspect of the invention, there is provided a resource access proxy comprising an apparatus according to any of the first and second aspects.

According to a fourth aspect of the invention, there is provided an apparatus comprising sending means for sending a service request to a first device; first receiving means for receiving a request for user interaction from a second device in order to comply with said service request, wherein the second device is different from the first device; requesting means for requesting said user interaction from a user interaction device; second receiving means for receiving said user interaction from said user interaction device; and responding means for responding, to said request for user interaction, based on said user interaction received from said user interaction device.

In the apparatus, said service request may comprise an identification of the device sending said service request.

The apparatus may further comprise third receiving means for receiving the service request from said user interface.

In the apparatus, said response to said request for user interaction may be adapted to trigger a second sending of said service request to said first device.

The apparatus may further comprise fourth receiving means for receiving a retry message comprising a handle in response to the service request; handle message providing means for providing a handle message comprising the handle to the second device, and the second receiving means may be adapted to receive the request for user interaction in response to the provision of the handle message.

The apparatus may further comprise identifying means for identifying the second device based on the received retry message comprising the handle.

In the apparatus, said request for user interaction may comprise an identification of said service request.

The apparatus may further comprise identifier generating means for generating an identifier for the service request, wherein said response to said request for user interaction may comprise said identifier of said service request.

The apparatus may further comprise fifth receiving means for receiving an error message in response to the service request; correlating means for correlating the error message with the request for user interaction based on said identifier.

According to a fifth aspect of the invention, there is provided an apparatus comprising sending processor for sending a service request to a first device; first receiving processor for receiving a request for user interaction from a second device in order to comply with said service request, wherein the second device is different from the first device; requesting processor for requesting said user interaction from a user interaction device; second receiving processor for receiving said user interaction from said user interaction device; and responding processor for responding, to said request for user interaction, based on said user interaction received from said user interaction device.

In the apparatus, said service request may comprise an identification of the device sending said service request.

The apparatus may further comprise third receiving processor for receiving the service request from said user interface.

In the apparatus, said response to said request for user interaction may be adapted to trigger a second sending of said service request to said first device.

The apparatus may further comprise fourth receiving processor for receiving a retry message comprising a handle in response to the service request; handle message providing processor for providing a handle message comprising the handle to the second device, and the second receiving processor may be adapted to receive the request for user interaction in response to the provision of the handle message.

The apparatus may further comprise identifying processor for identifying the second device based on the received retry message comprising the handle.

In the apparatus, said request for user interaction may comprise an identification of said service request.

The apparatus may further comprise identifier generating processor for generating an identifier for the service request, wherein said response to said request for user interaction may comprise said identifier of said service request.

The apparatus may further comprise fifth receiving processor for receiving an error message in response to the service request; correlating processor for correlating the error message with the request for user interaction based on said identifier.

According to a sixth aspect of the invention, there is provided a user interaction proxy comprising an apparatus according to any of the fourth and fifth aspects.

According to a seventh aspect of the invention, there is provided an apparatus, comprising first receiving means for receiving a service request from a first party; requesting means for requesting, in order to fulfill the service request, a resource from a second party; second receiving means for receiving a response to the request for the resource; detecting means for detecting if the response comprises a first retry message comprising a handle and a trigger for terminating service execution, compliant to the request for the resource; responding means for responding to the service request by a second retry message comprising the handle and a trigger for terminating service execution, compliant to the service request, if the detecting means detects that the response is the first retry message.

According to an eighth aspect of the invention, there is provided an apparatus, comprising receiving means for receiving a service request from a first party; requesting means for requesting, in order to fulfill the service request, a resource from a second party; wherein the service request comprises an identifier; and the request for the resource comprises the identifier.

According to a ninth aspect of the invention, there is provided an apparatus, comprising first receiving processor for receiving a service request from a first party; requesting processor for requesting, in order to fulfill the service request, a resource from a second party; second receiving processor for receiving a response to the request for the resource; detecting processor for detecting if the response comprises a first retry message comprising a handle and a trigger for terminating service execution, compliant to the request for the resource; responding processor for responding to the service request by a second retry message comprising the handle and a trigger for terminating service execution, compliant to the service request, if the detecting processor detects that the response is the first retry message.

According to an tenth aspect of the invention, there is provided an apparatus, comprising receiving processor for receiving a service request from a first party; requesting processor for requesting, in order to fulfill the service request, a resource from a second party; wherein the service request comprises an identifier; and the request for the resource comprises the identifier.

According to an eleventh aspect of the invention, there is provided a resource server, comprising an apparatus according to any of the seventh to tenth aspects.

According to a twelfth aspect of the invention, there is provided a System, comprising a first resource apparatus according to any of the first to third aspects; and a user interaction apparatus according to any of the fourth to sixth aspects; wherein the second party of the first resource apparatus comprises the user interaction apparatus; the second device of the user interaction apparatus comprises the first resource apparatus; the request for said user interaction of the first resource apparatus is the received request for user interaction of the user interaction apparatus; and the response to said user request for user interaction of the user interaction apparatus is the user interaction received by the first resource apparatus.

The system may further comprise second resource apparatus according to any of the seventh to eleventh aspects; wherein the first party of the first resource apparatus may comprise the second resource apparatus; the first device of the user interaction apparatus may comprise the second resource apparatus; the service request sent by the user interaction apparatus may be the service request received by the second resource apparatus; and the request for the resource of the second resource apparatus may be the service request received by the first resource apparatus.

According to a thirteenth aspect of the invention, there is provide a method, comprising receiving a service request from a first party; detecting a requirement for user interaction in order to comply with said service request; requesting said user interaction from a second party different from the first party; and receiving said user interaction as a response from said second party.

The method may be a method of user interaction.

In the method, said request for user interaction may comprise an information element for provisioning a user interface for executing said user interaction.

The method may further comprise requesting a second resource from a resource device in order to comply with said service request; and the detecting may be adapted to detect the requirement for user interaction based on an exception information received from the resource device in response to the request for the resource.

In the method, the user interaction may be requested from a user who has caused the service request received from the first party.

In the method, said request for user interaction may comprise an identification of said service request.

In the method, the requesting may be adapted to provide, together with said request for said user interaction, a transaction identifier, wherein the transaction identifier may be comprised in the service request received from the first party.

The method may further comprise responding to the first party, wherein the response may comprise a trigger for terminating service execution, compliant to the service request, in the first party.

The method may further comprise generating a handle which is related to the service request received from the first party, and wherein the handle is unique in the realm of an apparatus performing the method; detecting if a handle message comprising the handle is received by the apparatus from the second party; and the requesting may be adapted to request the user interaction if the handle message is detected.

The method may further comprise identifying the second party based on the handle message.

In the method, the service request may comprise a first user identification, the method may further comprise correlating a second service request from the first party with the received user interaction based on a second identification comprised in the second service request.

According to a fourteenth aspect of the invention, there is provided a method comprising sending a service request to a first device; receiving a request for user interaction from a second device in order to comply with said service request, wherein the second device is different from the first device; requesting said user interaction from a user interaction device; receiving said user interaction from said user interaction device; and responding, to said request for user interaction, based on said user interaction received from said user interaction device.

The method may be a method of user interaction.

In the method, said service request may comprise an identification of the device sending said service request.

The method may further comprise receiving the service request from said user interface.

In the method, said response to said request for user interaction may trigger a second sending of said service request to said first device.

The method may further comprise receiving a retry message comprising a handle in response to the service request; providing a handle message comprising the handle to the second device, and the request for user interaction may be received in response to the provision of the handle message.

The method may further comprise identifying the second device based on the received retry message comprising the handle.

In the method, said request for user interaction may comprise an identification of said service request.

The method may further comprise generating an identifier for the service request, wherein said response to said request for user interaction may comprise said identifier of said service request.

The method may further comprise receiving an error message in response to the service request; correlating the error message with the request for user interaction based on said identifier.

According to a fifteenth aspect of the invention, there is provided a method, comprising first receiving means for receiving a service request from a first party; requesting means for requesting, in order to fulfill the service request, a resource from a second party; second receiving means for receiving a response to the request for the resource; detecting means for detecting if the response comprises a first retry message comprising a handle and a trigger for terminating service execution, compliant to the request for the resource; responding means for responding to the service request by a second retry message comprising the handle and a trigger for terminating service execution, compliant to the service request, if the detecting means detects that the response is the first retry message.

According to a sixteenth aspect of the invention, there is provided a method, comprising receiving means for receiving a service request from a first party; requesting means for requesting, in order to fulfill the service request, a resource from a second party; wherein the service request comprises an identifier; and the request for the resource comprises the identifier.

The method according to any of the fifteenth and sixteenth aspects may be a method of service requesting.

According to a seventeenth aspect of the invention, there is provided a computer program product including a program comprising software code portions being arranged, when run on a processor of an apparatus, to perform the method according to any one of the thirteenth to sixteenth aspects.

The computer program product may comprise a computer-readable medium on which the software code portions are stored, and/or the program may be directly loadable into a memory of the processor.

By the apparatuses, methods, system, and computer program product, a smooth user experience may be provided without compromising security because it is avoided that services in the middle of the chain from the browser (or a related user interaction proxy) and the resource requesting a user information (or a related authentication proxy) are involved in the transmission of user credentials. That is, the credentials are kept as a secret between the browser (or its related user interaction proxy) and the service in question (or its related authentication proxy), and hidden from all other parties taking part in the service session.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an OAuth sequence;

FIG. 2 shows a simple example of a system comprising an OAuth proxy;

FIG. 3 shows a more complex example of a system comprising an OAuth proxy;

FIG. 4 shows a basic WS-Coordination flow;

FIG. 5 shows an example system with a workflow on which embodiments of the present invention are based;

FIG. 6 shows a system with a workflow according to an embodiment of the invention;

FIG. 7 shows a system with a workflow according to an embodiment of the invention;

FIG. 8 shows a system with a workflow according to an embodiment of the invention;

FIG. 9 shows an apparatus according to an embodiment of the invention;

FIG. 10 shows a method according to an embodiment of the invention;

FIG. 11 shows an apparatus according to an embodiment of the invention;

FIG. 12 shows a method according to an embodiment of the invention;

FIG. 13 shows an apparatus according to an embodiment of the invention;

FIG. 14 shows a method according to an embodiment of the invention;

FIG. 15 shows a system according to an embodiment of the invention; and

FIG. 16 shows a system according to an embodiment of the invention.

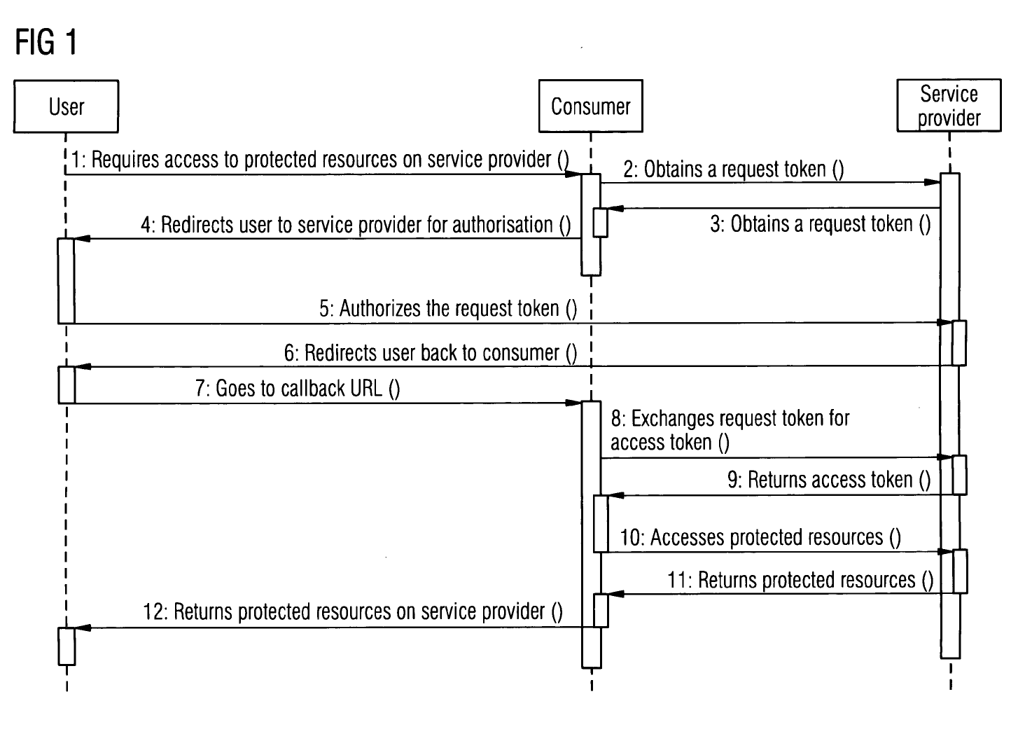

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

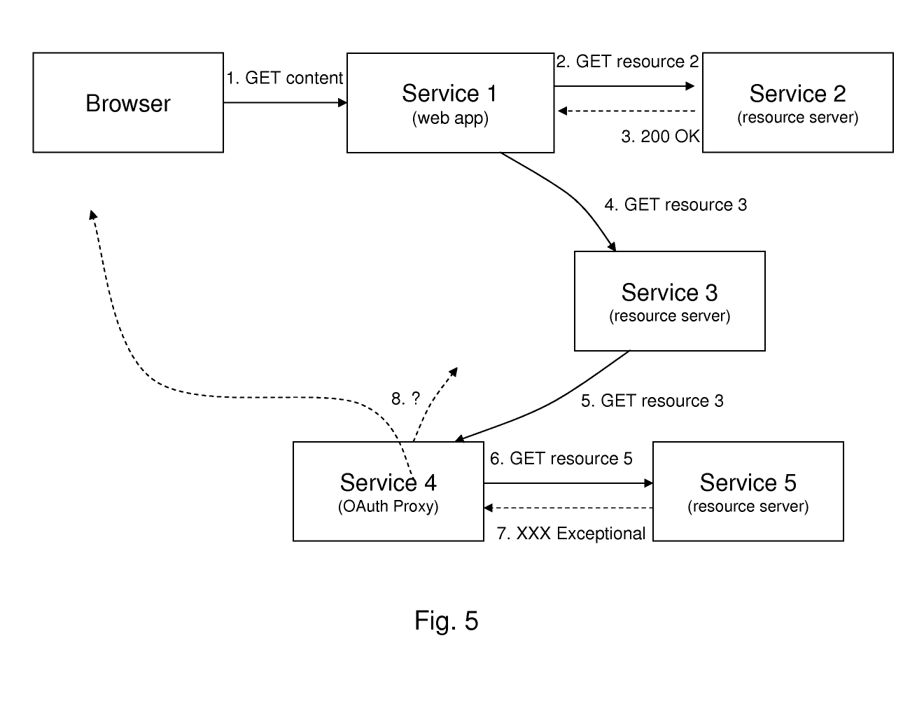

FIG. 5 shows a system with a workflow on which embodiments of the present invention may be based. The system is not limiting the invention, and other systems, e.g. involving more or less servers, and other workflows are within the scope of the invention. The system according to FIG. 5 is exemplarily used hereinafter to explain the present invention.

The system comprises a browser. The browser may be any browser such as MS Internet Explorer, Mozilla Firefox, Opera, etc., that allows user interaction.

For example, based on user interaction, the browser requests some content from Service 1 (1.). Service 1 may be a Web application such as iGoogle.

In order to fulfill the request, Service 1 may have to retrieve resources from Service 2 and Service 3 (2., 4.). Service 2 may response by providing the requested resource such as specific data (3.).

In order to fulfill the request of Service 1, Service 3 may have to request a resource from Service 4 (5.), which may be an OAuth proxy.

In order to fulfill the request of Service 3, Service 4 may have to request a resource from Service 5 (6.). Service 5 requires further information (such as a valid OAuth access token) in order to provide the requested resource. Since the information is not available, it responds to Service 4 with an exception message (7.). Service 4 (the OAuth proxy) needs to find a way how to get the required information. Getting the required information requires interaction with the end-user (e.g. redirecting the browser to Service 5 for authorizing an OAuth token). In general, there are two potential approaches (8.) to achieve this: Service 4 may request the required information following the way back via Service 3 and Service 1 to the browser, or it may directly contact the browser. The prior art does not provide a solution to this problem.

According to embodiments of the invention, an architecture and a workflow are as follows:
A User Interaction Proxy (UIP) resides between the browser (user agent) and the realm of cooperating services. All communication—requests and responses—between the browser to the services flow through the Proxy.
When a service such as Service 4 of FIG. 5 requires user interaction (or, more detailed, requires an information form the user that may be potentially obtained by user interaction), it requests the Proxy to insert a dialog (user interface, UI) into the communication flow. The way a service requests the Proxy to insert the dialog can vary. Some exemplary embodiments are outlined further below.
As the UIP is aware of all the pending requests from the browser to the services, it is able to insert the UI into the communication flow as a response to the pending request that initially triggered the cooperation of the services.

Note that the concept of relying on a proxy naturally fits into “controlled” service delivery environments—as opposed to the open Internet—where access to the services from the outside world happens in some controlled way. One example is the service Marketplace in the SERVERY project (http://wwm.celtic-initiative.org/projects/servery/) where access to the services is controlled by a gateway which is the single entry point to the services on the Marketplace. Another example is a group of service components deployed to a computing cloud where all the services reside behind an HTTP reverse proxy which is responsible for end-user authentication and access authorization. In such cases, the User Interaction Proxy is an additional function of the otherwise already present service access gateway.

In the following, some embodiments of the invention are described at greater detail, with reference to the exemplary architecture outlined in FIG. 5, wherein a user interaction proxy (UIP) as described hereinabove is inserted between the browser and Service 1.

A) Synchronous Variant:

In this variant, the service which needs user interaction synchronously contacts the User Interaction Proxy and waits until the user interaction is completed.

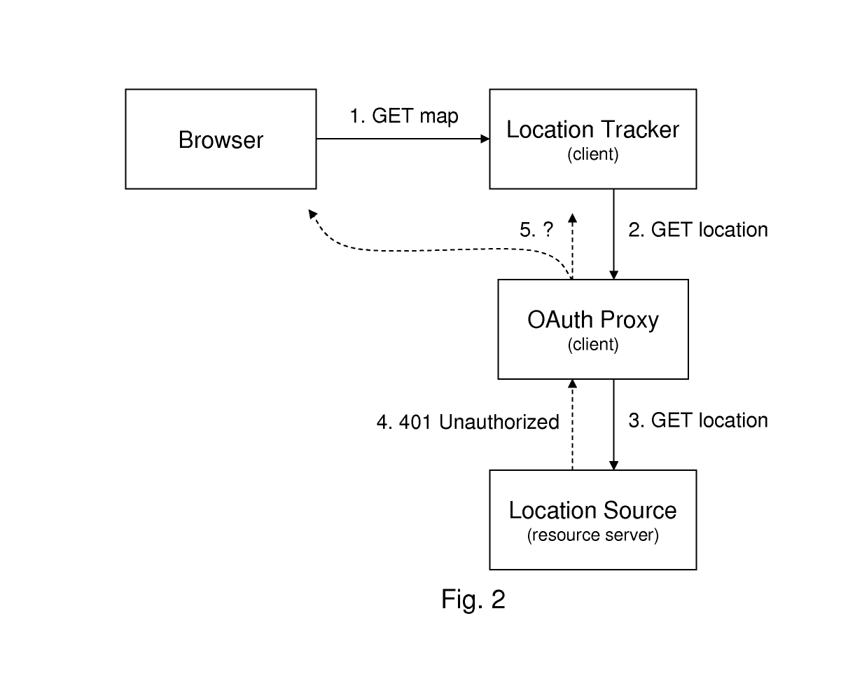

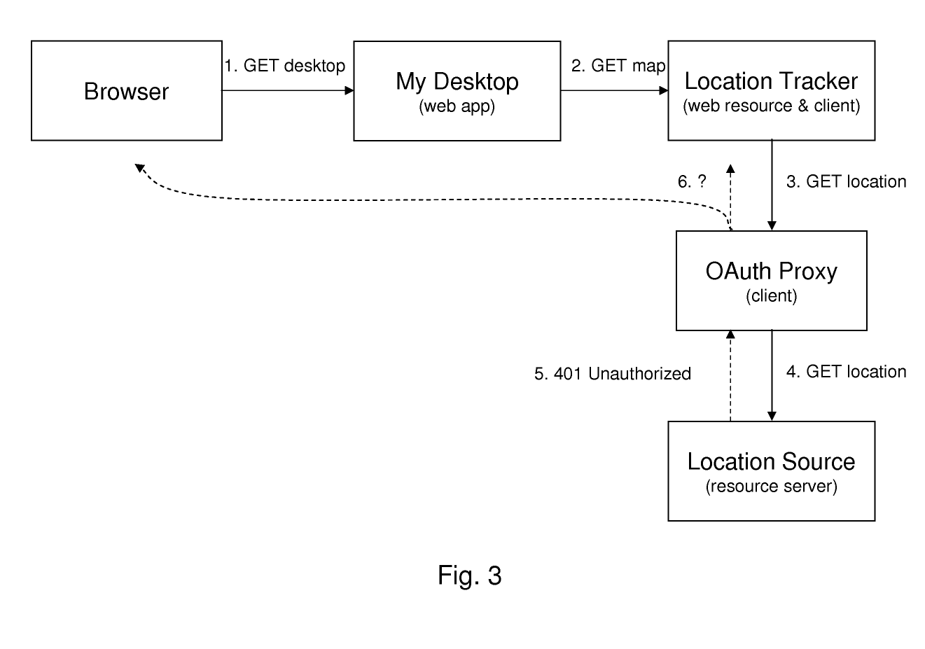

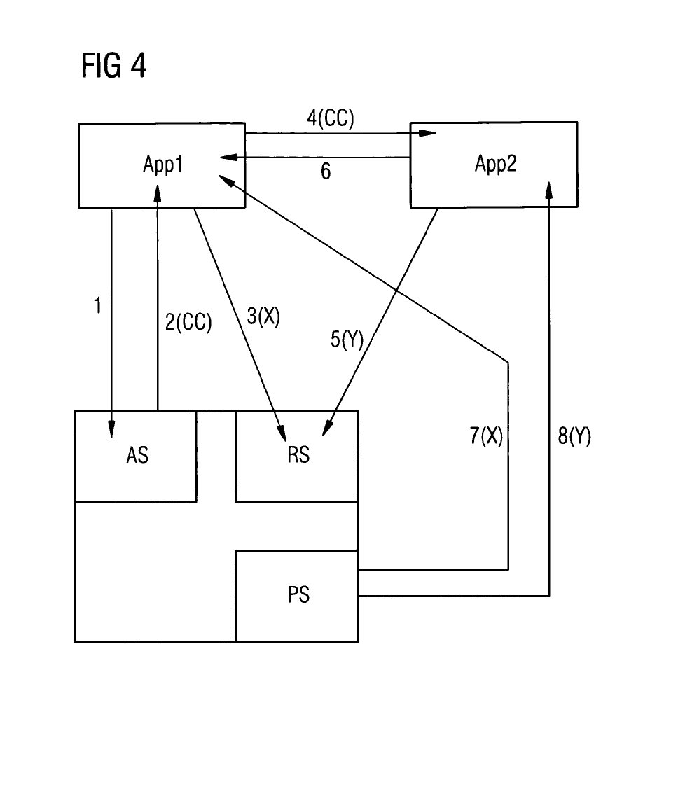

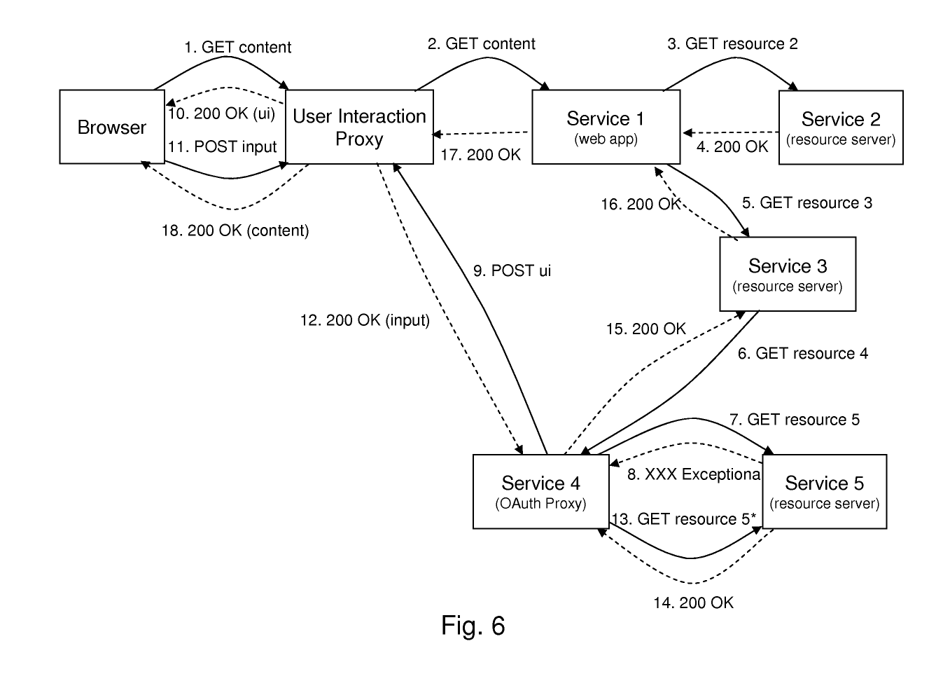

FIG. 6 illustrates the embodiment by means of HTTP message exchanges. Steps 1 to 8 are the same as Steps 1 to 7 of FIG. 5, wherein Step 1 of FIG. 5 is split into Steps 1 and 2 of FIG. 6 because of insertion of the UIP. Step 8 indicates the delivery of a 401 Unauthorized message returned by Service 5 (corresponding to the Location Source of FIG. 2 and FIG. 3) in response to the resource request in step 7.

Service 4 “suddenly” needs end-user interaction, so it contacts (9) the User Interaction Proxy (UIP) and passes a UI to it. The UIP returns (10) the UI to the Browser, the user inputs the required data, the Browser submits (11) the response to the Proxy, and eventually the Proxy returns (12) to Service 4 with the requested input, i.e. user information such as user credentials.

After having received the user input, Service 4 requests again the resource from Service 5 using the user input (13.). Then, Service 5 provides the requested resource to Service 4 (14.). Thereafter, Services 4, 3, and 1 propagate the respective resources back to the browser (via the UIP) in the usual way (15.-18.).

There may be two options how the authentication proxy (Service 4) may know the address of the UIP: The address of the UIP may be preconfigured in the authentication proxy, or the address is delivered with the request through the service chain. This may be achieved in that the UIP inserts a special HTTP header into the forwarded HTTP request telling its own address. E.g.:

GET .../my-desktop HTTP/1.1
X-User-Interaction-Proxy: http://.../uip
Host: ...

In this variant, neither Service 1 nor Service 2 or Service 3 is aware that an interaction with the user is required and ongoing. In particular, the user information is not passed through Services 1 to 3, avoiding a potential security threat.

This solution may cause a problem following from the synchronous nature of the call (9) from Service 4 to the User Interaction Proxy. All the services in the call chain (2, 5, 6) from the Proxy to Service 4—including Service 4 itself—are waiting for the user interaction to be completed. In other words, the threads of execution assigned to the requests in the chain are blocked. In real deployments, web servers and servlet containers may use thread pools with a fixed number of threads, the number typically falling into the range of hundreds (200-800; see http://www.springsource.com/files/uploads/tomcat/tomcatx-performance-tuning.pdf, for example). So a few hundred pending requests—waiting for end-user response—may block the server (“thread pool exhaustion”). The response time of web servers (without user interaction) is in the order of milliseconds, whereas the response time of users is around a second in the best case. However, users sometimes do not answer immediately if ever (e.g. doing something else or being away from the computer).

This problem may be overcome by asynchronous variants of embodiments of the invention as outlined below:

B) Asynchronous Variant with Retry Handle:

In this variant, the synchronous call to the User Interaction Proxy from the service (or its related authentication proxy such as Service 4 in FIG. 5)—which needs user interaction—is replaced with retry and callback (the Proxy calling the service).

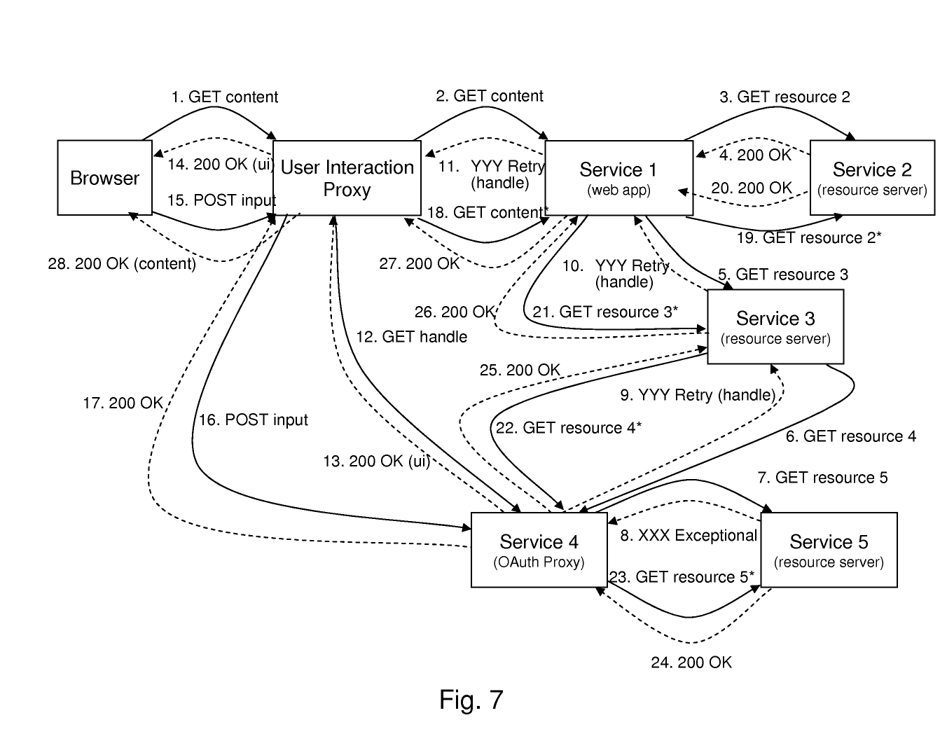

An embodiment of this variant is shown in FIG. 7. Steps 1 to 8 are the same as the corresponding steps in FIG. 6.

Service 4 now returns (9.) immediately with a special response to Service 3, and this special response is propagated (10., 11.) by the services in the call chain (in the example: Services 1 and 3) back to the User Interaction Proxy. The special response also contains a handle which uniquely identifies the case in the realm of Service 4.

The Proxy recognizes the special response and does not propagate it back to the Browser; instead, it extracts the handle and contacts (12.) Service 4 directly, passing the handle, to retrieve (13.) the necessary UI. Then it sends (14.) the UI to the Browser, receives (15.) the input, and sends (16.) the input (user information) to Service 4. Then the user interaction proxy repeats (18.) the original request (i.e. the request of step 2.), resulting in a similar call chain (19.-22.) as before.

After having received the user information (16.) and the repeated request (22.), Service 4 requests again the resource from Service 5 using the user input (23.). Then, Service 5 provides the requested resource to Service 4 (24.). Thereafter, Services 4, 3, and 1 propagate the respective resources back to the browser (via the UIP) in the usual way (25.-28.).

In this variant, the UIP may contact the authentication proxy taking the address of the authentication proxy from the www-authenticate header returned by the authentication proxy in the special response (e.g. a special HTTP 401 response). Thus, the authentication proxy does not have to know the address of the UIP.

Service 4 may correlate the received user information and the repeated request e.g. by a user identification if is transported from the UIP through the chain of Services (Services 1 to 4), and if it is comprised in the user information.

This way, the user information is not passed through Services 1 to 3, avoiding a potential security threat. In addition, the open threads of the first request chain (steps 2. to 7.) are closed within the usual response time for webservices, i.e. milliseconds, such that the servers are not blocked.

If the user information has a sufficient long lifetime, it may be used for several requests of the same user. Thus, a user need not to input its user information once for each request, and user convenience is achieved without compromising security, if the authentication proxy (Service 4) is secure. If, on the other side, the user information is valid for one request only, it may be correspondingly marked in the message from the UIP to the authentication proxy.

In some embodiments, the correlation required for the asynchronous variants between the user information received at the authentication proxy (Service 4 in FIG. 7) and the repeated request from Service 3 may be based on an identifier which preferably should be unique in the realm of the authentication proxy. For example, the handle may be comprised in the repeated requests (steps 18. to 25. in FIG. 7). The handle may be but need not be included in the message transmitting the user information from the UIP to the authentication proxy (step 16. in FIG. 7) because this dialogue between UIP and authentication proxy is triggered by the transmission of the handle in step 12.

Thus, an unambiguous correlation of the repeated request and the user information may be achieved. However, the service chain has to support the transmission of the identifier from the UIP to the authentication proxy.

The following sequence illustrates one possible implementation of variant B by means of HTTP messages. It shows an embodiment where variant B (FIG. 7) is applied to the OAuth Proxy problem (FIG. 3); the numbering of the steps is in line with the message numbering in FIG. 7. The correspondence of the Services in FIG. 7 and the notations in the sequence are as follows:

| - | User Interaction proxy: my desktop; | |
|---|---|---|
| - | Service 1: My Desktop | |
| - | Service 3: LocationTracker | |
| - | Service 5: LocationSource | |
| 1. | The Browser issues an HTTP request to My Desktop. But | |
| | since the User Interaction Proxy resides between the | |
| | Browser and the service, it is actually received by the | |
| | Proxy: | |
| | | GET .../my-desktop HTTP/1.1 |
| | | Host: ... |
| 2. | The User Interaction Proxy forwards the request to the | |
| | My Desktop: | |
| | | GET .../my-desktop HTTP/1.1 |
| | | Host: ... |
| 3. | ... (intentionally left blank to stay in line Fig. 7). | |
| 4. | ... | |
| 5. | My Desktop requests the map from Location Tracker: | |
| | | GET .../location-tracker HTTP/1.1 |
| | | Host: ... |
| 6. | Location Tracker → OAuth Proxy: | |
| | | GET .../location-source?id=user1234 HTTP/1.1 |
| | | Host: ... |
| 7. | OAuthProxy → LocationSource: | |
| | | GET .../location-source?id=user1234 HTTP/1.1 |
| | | Host: ... |
| 8. | LocationSource --> OAuthProxy (as the request did not | |
| | contain a valid access token; the Token authentication | |
| | scheme is defined by the OAuth specification): | |
| | | HTTP/1.1 401 Unauthorized |
| | | WWW-Authenticate: Token realm=″...″ error=″...″ |
| | | ... |
| 9. | OAuthProxy → LocationTracker: | |
| | | HTTP/1.1 401 Unauthorized |
| | | WWW-Authenticate: Proxy realm=″...″ |
| | | url=″http://.../oauth-proxy/case2345″ |
| | | ... |
| | Notice the Proxy authentication scheme which is a | |
| | fictitious one, just serving as an example; in | |
| | combination with the 401 response code, it implements | |
| | the “Retry” response shown in Fig. 7; the case2345 | |
| | identifier in the url field implements the “handle” | |
| | shown in Fig. 7. | |
| 10. | | Location Tracker → My Desktop (just propagating |
| | the Unauthorized response): | |
| | | HTTP/1.1 401 Unauthorized |
| | | WWW-Authenticate: Proxy realm=″...″ |
| | | url=″http://.../oauth-proxy/case2345″ |
| | | ... |
| 11. | | My Desktop → User Interaction Proxy: |
| | | HTTP/1.1 401 Unauthorized |
| | | WWW-Authenticate: Proxy realm=″...″ |
| | | url=″http://.../oauth-proxy/case2345″ |
| | | ... |
| 12. | | The User Interaction Proxy recognizes the Proxy |
| | authentication scheme, retrieves the URL of the OAuth | |
| | Proxy from the WWW-Authenticate field, and contacts the | |
| | OAuth Proxy: | |
| | | GET .../oauth-proxy/case2345 HTTP/1.1 |
| | | Host: ... |
| 13. | | OAuth Proxy → User Interaction Proxy: |
| | | HTTP/1.1 200 OK |
| | | Content-Type: text/plain |
| | | Content-Length: ... |
| | | HTTP/1.1 302 Found |
| | | Location: https://.../location- |
| | | source/authorize?type=web_server&client_id=client34 |
| | | 56&redirect_uri=https%3A%2F%2F...%2Foauth- |
| | | proxy/case2345 |
| | | ... |
| | Notice that the HTTP response (200) contains another | |
| | HTTP response (302) in its body. This latter HTTP | |
| | response is in fact the implementation of the “ui” | |
| | indicated Fig. 7. | |
| 14. | | The User Interaction Proxy extracts the redirection |
| | (302) response from the received message and returns it | |
| | to the Browser: | |
| | | HTTP/1.1 302 Found |
| | | Location: https://.../location- |
| | | source/authorize?type=web_server&client_id=client34 |
| | | 56&redirect_uri=https%3A%2F%2F...%2Foauth- |
| | | proxy/case2345 |
| | | ... |
| | The user interaction will now take place, which - due to | |
| | the nature of the OAuth protocol - takes a more | |
| | complicated form than the simple “input” indicated in | |
| | Fig. 7. | |
| | a. | Browser → User Interaction Proxy → Location |

Source (the request also being proxied by the User
Interaction Proxy, but not shown in separate steps
here):

| | GET .../location- |
|---|---|
| | source/authorize?type=web_server&client_id=client34 |
| | 56&redirect_uri=https%3A%2F%2F...%2Foauth- |
| | proxy/case2345 HTTP/1.1 |
| | Host: ... |
| b. | ... |
| c. | ... (according to OAuth, the Location Source first |

authenticates the user; steps not shown)

| | |
|---|---|
| d. | ... |
| e. | Browser → User Interaction Proxy → Location |

Source (user authorizes the access):

| | POST .../location- |
|---|---|
| | source/authorize?type=web_server&client_id=client34 |
| | 56&redirect_uri=https%3A%2F%2F...%2Foauth- |
| | proxy/case2345 HTTP/1.1 |
| | Host: ... |
| f. | Location Source → User Interaction Proxy → |

Browser :

| | | HTTP/1.1 302 Found |
|---|---|---|
| | | Location: https://.../oauth- |
| | | proxy/case2345?code=code4567 |
| | | ... |
| 15. | | Browser → User Interaction Proxy: |
| | | GET .../oauth-proxy/case2345?code=code4567 HTTP/1.1 |
| | | Host: ... |
| 16. | | User Interaction Proxy → OAuth Proxy: |
| | | GET .../oauth-proxy/case2345?code=code4567 HTTP/1.1 |
| | | Host: ... |
| | Two more OAuth-specific steps take place; the OAuth | |
| | Proxy obtains an access token from the Location Source | |
| | in exchange to the access code (code4567): | |
| | a. | OAuth Proxy → Location Source: |
| | | POST .../location-source/token HTTP/1.1 |
| | | Host: ... |
| | | Content-Type: application/x-www-form-urlencoded |
| | | Content-Length: ... |
| | | grant_type=authorization_code&client_id=...&client_{—} |
| | | secret=...&code=code4567&redirect_uri=https%3A%2F%2 |
| | | F...%2Foauth-proxy/case2345 |
| | b. | Location Source → OAuth Proxy: |

HTTP/1.1 200 OK
Content-Type: application/json
Content-Length: ...
Cache-Control: no-store
{

″access_token″:″token56789″,
″expires_in″:3600

}

The OAuth Proxy caches the received access token for
later use (step 23).

| | |
|---|---|
| 17. | OAuth Proxy → User Interaction Proxy: |
| | HTTP/1.1 200 OK |
| | ... |
| 18. | User Interaction Proxy → My Desktop (repeating |

request of step 2):

| | |
|---|---|
| | GET .../my-desktop HTTP/1.1 |
| | Host: ... |
| 19. | ... (repeating request of step 3; intentionally left |

blank to stay in line with Fig. 7).

| | |
|---|---|
| 20. | ... |
| 21. | My Desktop → Location Tracker (repeating request |

of step 5):

| | |
|---|---|
| | GET .../location-tracker HTTP/1.1 |
| | Host: ... |
| 22. | Location Tracker → OAuth Proxy (repeating request |

of step 6):

| | |
|---|---|
| | GET .../location-source?id=user1234 HTTP/1.1 |
| | Host: ... |
| 23. | OAuth Proxy → Location Source (repeating request |

of step 7, but now with a valid access token included):

| | |
|---|---|
| | GET .../location-source?id=user1234 HTTP/1.1 |
| | Host: ... |
| | Authorization: Token realm=″...″ token=″token56789″ |
| | ... |
| 24. | Location Source → OAuth Proxy (return geo-location |

coordinates):

HTTP/1.1 200 OK
Content-Type: application/json
Content-Length: ...
Cache-Control: no-store
{

″lat″: 57.502098,
″lng″: 18.057159,

| | |
|---|---|
| | } |
| 25. | OAuth Proxy → Location Tracker: |
| | HTTP/1.1 200 OK |
| | Content-Type: application/json |
| | Content-Length: ... |
| | Cache-Control: no-store |
| | { |

″lat″: 57.502098,
″lng″: 18.057159,

| | |
|---|---|
| | } |
| 26. | Location Tracker → My Desktop (return map with |

user's location indicated):

| | |
|---|---|
| | HTTP/1.1 200 OK |
| | ... |
| 27. | My Desktop → User Interaction Proxy (return |

desktop with map embedded):

| | |
|---|---|
| | HTTP/1.1 200 OK |
| | ... |
| 28. | User Interaction Proxy → Browser: |
| | HTTP/1.1 200 OK |

C) Asynchronous Variant with Transaction Id:

This variant of some embodiments of the invention avoids the “thread pool exhaustion” problem (as variant B does) and does not need a special response message (“retry”) as according to variant B. Furthermore, an unambiguous correlation between the repeated request and the user information may be reached.

Steps 1. to 8. are the same as those of FIG. 7. However, the requests in steps 2. to 6. comprise a transaction Id generated by the UIP and unique in the realm of the UIP. When the authentication proxy (Service 4) receives the exception message (8.), it directly contacts the UIP (9.), whose address is known as in the synchronous variant, and passes a user interface and the transaction ID to the UID. Only then, Service 4 returns an error message to Service 3 (10.), which is propagated back to the UIP (11., 12.). The error message may be a conventional one.

The UIP receives both the message from the authentication proxy and the error message and may correlate them by the transaction Id. Thus, it knows that a user interaction is required, requests the user input from the browser as in variants A and B (13., 14.), and sends it to the authentication proxy in response to its message comprising the user interface and transaction Id (15.).

Then, it repeats the original request to Service 1 (the request of step 2.) including the same transaction Id (16.-20.).

When the authentication proxy receives both the user information and the repeated request from the UIP through the Service chain, it may correlate them based on the transaction Id. Then, Service 4 requests again the resource from Service 5 using the user input (21.). Service 5 provides the requested resource to Service 4 (22.). Thereafter, Services 4, 3, and 1 propagate the respective resources back to the browser (via the UIP) in the usual way (23.-26.).

In this variant, neither Service 1 nor Service 2 or Service 3 is aware that an interaction with the user is required and ongoing. In particular, the user information is not passed through Services 1 to 3, avoiding a potential security threat. In addition, the open threads of the first request chain (steps 2. to 7.) are closed within the usual response time for webservices, i.e. milliseconds, such that the servers are not blocked.

During its lifetime, the transaction Id should be unique in the realm of the UIP. In order to make the transaction Id unique in the realm of the authentication proxy, too, which is preferable in order to achieve an unambiguous correlation of the repeated request and the user information, the transaction Id may preferably comprise an identification of the UIP which is unique in the network, such as a MAC address.

In some embodiments of variant C, it may be preferred that the user information may be used for several requests of the same user. If user identification is provided with the requests, this may be achieved by the same correlation as in variant B. Alternatively, it may be achieved in that the correlation of the first request using user information is correlated based on the transaction Id. Then, a user identification of this request is retrieved and associated to the user information. Subsequent requests of the same user may then be correlated to the user information during its lifetime.

Adaptation to AJAX-Based Web Applications

An option of insertion of the UI according to some embodiments of the invention, as described in the previous sections (messages 10-11 in FIGS. 6 and 14-15 in FIG. 7) is described in detail hereinafter. Many modern Web UIs are based on AJAX (Asynchronous JavaScript and XML; http://en.wikipedia.org/wiki/Ajax(programming)), which is “a group of interrelated web development techniques used on the client-side to create interactive web applications. With Ajax, web applications can retrieve data from the server asynchronously in the background without interfering with the display and behavior of the existing page. The use of Ajax techniques has led to an increase in interactive or dynamic interfaces on web pages. Data is usually retrieved using the XMLHttpRequest object”.

For AJAX-based Web UIs, the insertion of the UI may be done in the following way. The Web UI keeps an HTTP connection continuously open to the User Interaction Proxy, corresponding to message 1 in FIG. 6 or FIG. 7). Then whenever the User Interaction Proxy is requested to insert a UI, it does it in response to the pending HTTP request. To avoid the “thread pool exhaustion” problem, a preferable solution may be using a polling technique: instead of keeping the HTTP connection continuously open, the client periodically checks for a potential UI request.

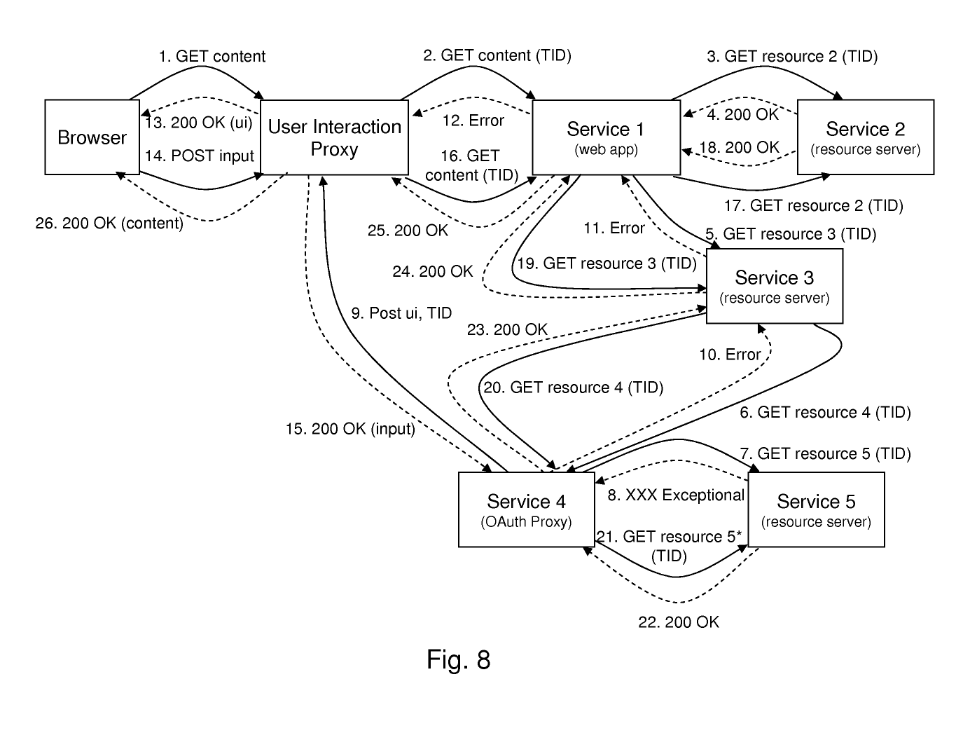

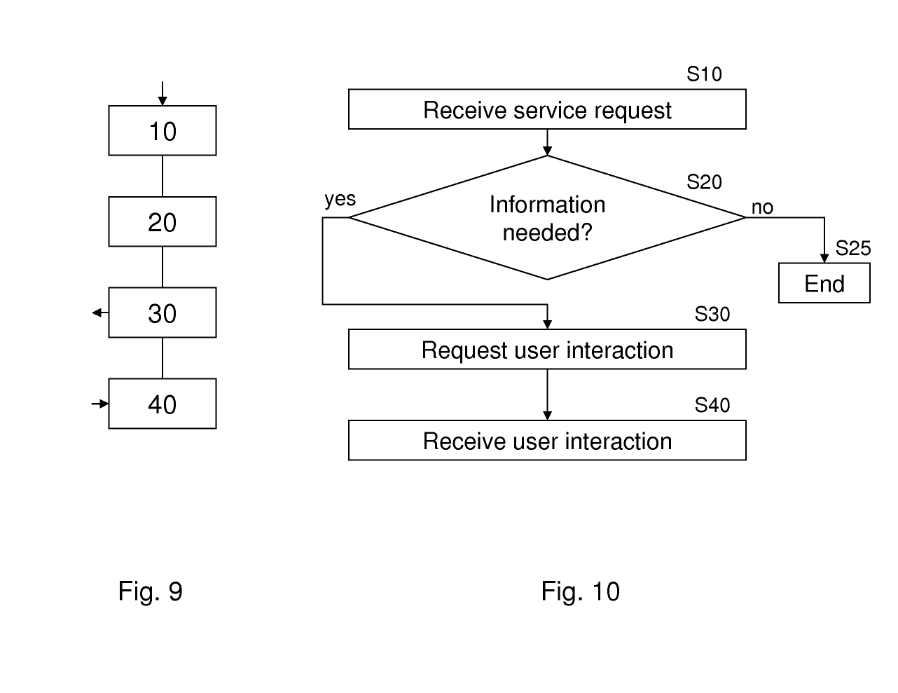

FIG. 9 shows an apparatus according to an embodiment of the invention. The apparatus may be an authentication proxy, such as Service 4 of FIGS. 6 to 8. FIG. 10 shows a method according to an embodiment of the invention. The apparatus according to FIG. 9 may perform the method of FIG. 10 but is not limited to this method. The method of FIG. 10 may be performed by the apparatus of FIG. 9 but is not limited to being performed by this apparatus.

The apparatus comprises a first receiving means 10, a detecting means 20, a requesting means 30, and a second receiving means 40.

According to step S10 which may be performed by the first receiving means 10, a service request is received from a first party such as Service 3 of FIGS. 6 to 8. According to step S20, which may be performed by detecting means 20, it is detected if a user interaction is required in order to comply with said service request. An example for such detection is the detection of the error message from Service 5 in FIGS. 6 to 8. More in detail, the need for user interaction may be a need for a user related information which may be possibly obtained by user interaction.

If no user interaction is needed, the method ends (step S25).

If user interaction is required, the requesting means 30 may request user information from a second party such as the user interaction proxy of FIGS. 6 to 8 (step S30). The second party is different from the first party. The request may comprise e.g. a user interface.

In step S40, which may be performed by the second receiving means 40, the user interaction (more detailed: the user related information) is received from the second party.

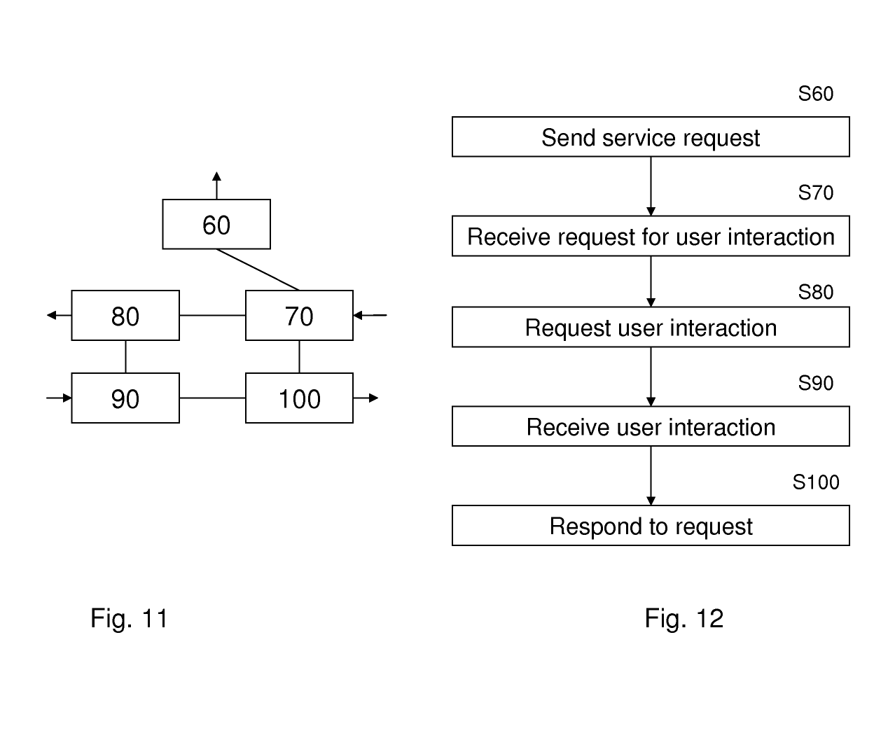

FIG. 11 shows an apparatus according to an embodiment of the invention. The apparatus may be a user interaction proxy, such as the one of FIGS. 6 to 8. FIG. 12 shows a method according to an embodiment of the invention. The apparatus according to FIG. 11 may perform the method of FIG. 12 but is not limited to this method. The method of FIG. 12 may be performed by the apparatus of FIG. 11 but is not limited to being performed by this apparatus.

The apparatus comprises a sending means 60, a first receiving means 70, a requesting means 80, a second receiving means 90, and a responding means 100.

According to step S60 which may be performed by the resource requesting means 60, a service request is sent to a first device such as Service 1 of FIGS. 6 to 8.

According to step S70, which may be performed by the first receiving means 70, a request for user interaction may be received from a second device in order to comply with the service request sent according to step S60. The second device is different from the first device.

Upon having received the request, the user interaction is requested from a user interaction device such as the browser of FIGS. 6 to 8 (step S80). Step S80 may be performed by requesting means 80.

According to step S90, which may be performed by the second receiving means 90, the user interaction is received in response to the request. The responding means 100 provides a response to the second device (step S100). The response is based on the received user interaction.

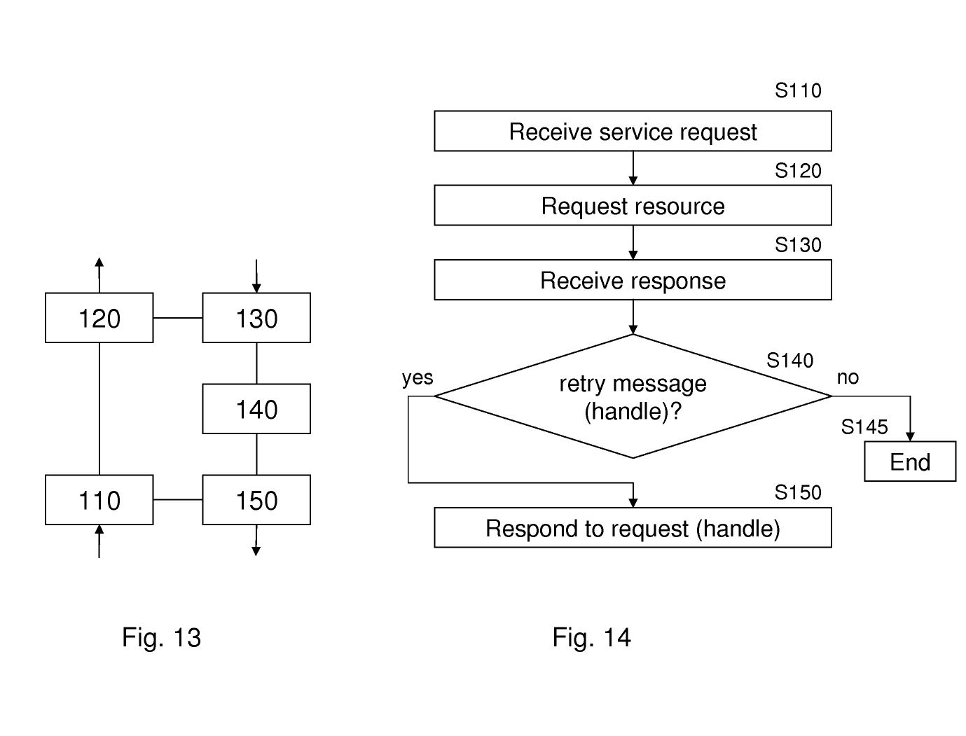

FIG. 13 shows an apparatus according to an embodiment of the invention. The apparatus may be a resource server, such as Service 1, Service 2, and Service 3 of FIGS. 6 and 7. FIG. 14 shows a method according to an embodiment of the invention. The apparatus according to FIG. 13 may perform the method of FIG. 14 but is not limited to this method. The method of FIG. 14 may be performed by the apparatus of FIG. 13 but is not limited to being performed by this apparatus.

The apparatus comprises a first receiving means 110, a requesting means 120, a second receiving means 130, a detecting means 140, and a responding means 150.

According to step S110 which may be performed by the first receiving means 110, a service request is received from a first party. In order to fulfill the service request, according to step S120 which may be performed by requesting means 120, a resource is requested from a second party. The second party may be different from the first party.

The second receiving means 130 may receive, according to step S130, a response to the request for the resource.

In step S140, the detecting means 140 detects if, the response to the request for the resource comprises a retry message. In some embodiments, the apparatus may close the thread related to the request for the resource upon receipt of the retry message. Furthermore, the detecting means 140 checks in step S140 whether the retry message includes a handle.

If no retry message is detected or the retry message does not comprise the handle, the method is terminated (step S145).

Otherwise, in response to the service request, a retry message comprising the handle is provided to the first party (S150). This step may be performed by the responding means 150. In some embodiments, the thread related to the service request may be closed upon responding with the retry message.

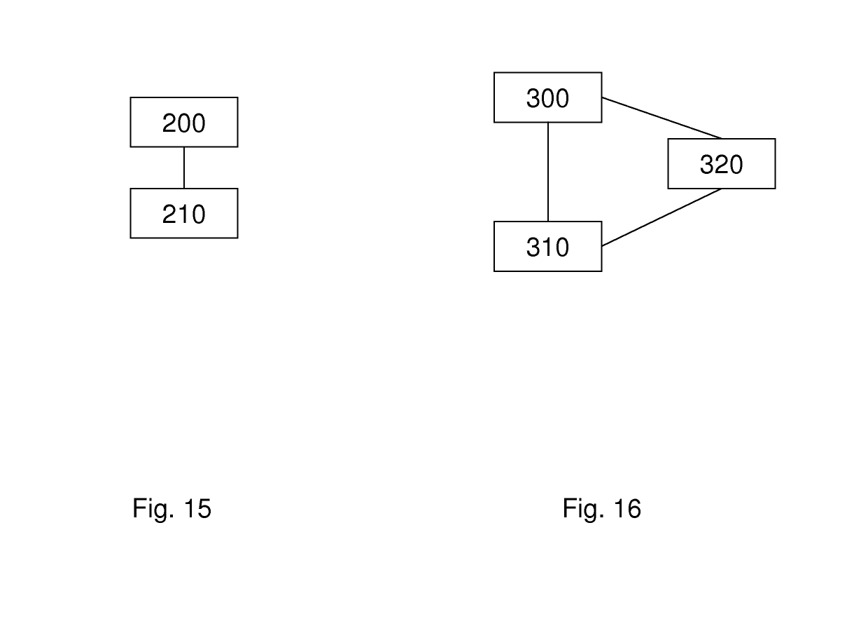

FIG. 15 shows a system according to an embodiment of the invention. The system comprises a first resource apparatus 210 such as Service 4 in FIGS. 6 to 8 and the apparatus shown in FIG. 9, and a user interaction apparatus 200 such as the user interaction proxy in FIGS. 6 to 8 and the apparatus shown in FIG. 11.

The user interaction apparatus 200 provides a user interaction to the first resource apparatus 210 in response to a corresponding request from the first resource apparatus 210.

The system according to an embodiment of the invention shown in FIG. 16 corresponds to that of FIG. 15. That is, it comprises a first resource apparatus 210 such as Service 4 in FIGS. 6 to 8 and the apparatus shown in FIG. 9, and a user interaction apparatus 200 such as the user interaction proxy in FIGS. 6 to 8 and the apparatus shown in FIG. 11. Furthermore, it comprises a second resource apparatus 230. The second resource apparatus may comprise one or more resources or services, such as Services 1 to 3 in FIGS. 6 to 8.

In the system of FIG. 16, a service request corresponding to a request for a resource is passed from the user interaction apparatus 200 via the second resource apparatus 220 to the first resource apparatus 210. The user interaction apparatus 200 provides a user information to the first resource apparatus 210 in response to a request for a user interaction received from the first resource apparatus 210.

The system of FIG. 16 corresponds e.g. to the systems shown in FIGS. 6 to 8.

The leap from variant A to variant B (or variant C) may be interpreted as “trading execution thread for retry+handle (transaction ID)”, or in other words “externalizing” the (internal) execution state (call stack) to “ordinary” data i.e. the handle (transaction Id) and the data associated with the handle (transaction Id) at Service 4 and at the User Interaction Proxy.

In some embodiments, based on this consideration, a Web Services choreography may be employed: In these embodiments, there is a set of cooperating services, one invoicing the other. Whenever a service “gets stuck”, i.e. does not know how to handle a situation (e.g. because an information is missing), it returns a “retry” response with a handle in it. The service receiving the “retry” response either knows how to deal with it, or not. In the latter case, it blindly propagates the response back to its caller. In the former case, it handles the case and then helps the “stuck” service resume its computation, as outlined in detail for the case of missing user information according to variant B herein.

One class of possible use cases—besides user interaction—is where a service “deep inside” the service web requires some additional context information. For example, it may miss an assertion from a trusted source that the user has enough credit for the requested service to be performed (a composite service may involve sending an SMS). Another example is where the service expects the operation to be performed inside a transaction environment, but there is no such. Such use cases are expected to arise more and more frequently as end-users will be able to compose new services from already available service elements or enablers, or other users' services, which is one key driver of the SERVERY project.

Some embodiments are described with respect to a http protocol. However, in other embodiments other protocols may be used as long as they are request-response protocols, where “a requestor sends a request message to a replier system which receives and processes the request, ultimately returning a message in response” (http://wikipedia.org/wiki/Request-response).

In the embodiments of FIGS. 6 to 8, Service 4 requests a user interaction from the user interaction proxy by providing a user interface. In some embodiments, the request may comprise a reference to a user interface or another information element for provisioning a user interface. An example is given in the message flow outlined with respect to FIG. 7 above: In step 13 of the message flow, the HTTP response (200) contains another HTTP response (302) in its body. This latter HTTP response is an implementation of an information element for provisioning the user interface (UI). Thus, the returned content is not the UI itself but an HTTP redirect message which, after the UIP propagates it to the browser, will redirect the browser to Service 5 which in turn will return the UI itself (i.e. the question: “do you authorize [Service 3] to access your data?”).

Instead or in addition of triggering the request for authentication by an exception message as according to the embodiments above, other conditions may trigger a workflow according to embodiments of the invention: For example, Service 4 may comprise an indication that Service 5 requires user interaction. Thus, it may not need to request the resource from Service 5 but immediately take care of obtaining the user information, and only then request the resource from Service 5 using the obtained user information.

The user information passed from the UID to the authentication proxy may have an infinite or predefined finite lifetime, and/or may be usable for a predefined number of requests.

If not otherwise stated or otherwise made clear from the context, the statement that two entities are different means that they are differently addressed in the communication network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example an authentication proxy such as an OAuth proxy, or a component thereof, an apparatus embodying the same, a method for controlling and/or operating the same, and computer program(s) controlling and/or operating the same as well as mediums carrying such computer program(s) and forming computer program product(s). Further exemplary embodiments of the present invention provide, for example a user interaction proxy, or a component thereof, an apparatus embodying the same, a method for controlling and/or operating the same, and computer program(s) controlling and/or operating the same as well as mediums carrying such computer program(s) and forming computer program product(s) controlling and/or operating the same as well as mediums carrying such computer program(s) and forming computer program product(s). Still further exemplary embodiments of the present invention provide, for example a resource server, or a component thereof, an apparatus embodying the same, a method for controlling and/or operating the same, and computer program(s) controlling and/or operating the same as well as mediums carrying such computer program(s) and forming computer program product(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

The proposed solution is capable of coping with user interaction triggered by any of the services inside a web of cooperating services. In embodiments according to variants A and C—unlike in the solutions listed in the prior art section—none of the other services notice that a user interaction is taking place, taking this burden off of the service developers' shoulder, hence simplifying service development. According to variant A, a price of this elegance is the “thread pool exhaustion” problem, according to variant C it is the requirement of transmitting the transaction Id. Embodiments of variants B and C counter the “thread pool exhaustion” problem; the price of this enhancement is that the services in the call chain must be able to cope with a special response type which we denoted by “retry” (variant B) or with the transmission of the transaction Id (variant C).

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-49. (canceled)

50. An apparatus, comprising:
a first receiving processor configured to receive a service request from a first party;
a detecting processor configured to detect a requirement for a first identification of the user in order to comply with said service request;
a checking processor configured to check if any identification of the user is available at the apparatus;
a requesting processor configured to request, if any identification of the user is not available, said first identification of the user from a second party different from the first party; and
a second receiving processor configured to receive said first identification of the user as a response from said second party.

51. An apparatus according to claim 50, wherein
said request for the first identification of the user comprises an information element for provisioning a user interface for executing said identification of the user.

52. The apparatus according to claim 50, further comprising:
a resource requesting processor configured to request a second resource from a resource device in order to comply with said service request, wherein
the detecting processor is configured to detect the requirement for the first identification of the user based on an exception information received from the resource device in response to the request for the resource.

53. The apparatus according to claim 50, wherein said request for the first identification of the user comprises an identification of said service request.

54. The apparatus according to claim 50, wherein
the requesting processor is configured to provide, together with said request for said first identification of the user, a transaction identifier, wherein the transaction identifier is comprised in the service request received from the first party.

55. The apparatus according to claim 50, further comprising
a response processor configured to send a response to the first party, wherein the response to the first party comprises a trigger for terminating service execution, compliant to the service request, in the first party.

56. The apparatus according to claim 50, further comprising
a handle generating processor configured to generate a handle which is related to the service request received from the first party, and wherein the handle is unique in the realm of the apparatus;
a handle detecting processor configured to detect if a handle message comprising the handle is received by the apparatus from the second party; wherein
the requesting processor is configured to request the first identification of the user if the handle message is detected.

57. The apparatus according to claim 56, further comprising
an identifying processor configured to identify the second party based on the handle message.

58. A resource access proxy comprising an apparatus according to claim 50.

59. An apparatus, comprising:
a sending processor configured to send a service request to a first device;
a first receiving processor configured to receive a request for user interaction from a second device in order to comply with said service request, wherein the second device is different from the first device;
a requesting processor configured to request said user interaction from a user interaction device without having received a response to the service request for user interaction from the first device;
a second receiving processor configured to receive said user interaction from said user interaction device; and
a responding processor configured to respond, to said request for user interaction, based on said user interaction received from said user interaction device.

60. The apparatus according to claim 59, wherein
said service request comprises an identification of the device sending said service request.

61. The apparatus according to claim 59, wherein
said request for user interaction comprises an identification of said service request.

62. The apparatus according to claim 61, further comprising:
an identifier generating processor configured to generate an identifier for the service request, wherein said response to said request for user interaction comprises said identifier of said service request.

63. The apparatus according to claim 62, further comprising:
a fifth receiving processor configured to receive an error message in response to the service request;
a correlating processor configured to correlate the error message with the request for user interaction based on said identifier.

64. The apparatus according to claim 59, wherein
said response to said request for user interaction is configured to trigger a second sending of said service request to said first device.

65. The apparatus according to claim 59, further comprising
a third receiving processor configured to receive the service request from said user interface.

66. A user interaction proxy comprising an apparatus according to claim 59.

67. An apparatus, comprising:
a sending processor configured to send a service request to a first device;
a first receiving processor configured to receive a request for user interaction from a second device in order to comply with said service request, wherein the second device is different from the first device;
a requesting processor configured to request said user interaction from a user interaction device;
a second receiving processor configured to receive said user interaction from said user interaction device;
a responding processor configured to respond, to said request for user interaction, based on said user interaction received from said user interaction device;
a fourth receiving processor configured to receive a retry message comprising a handle in response to the service request;
a handle message providing processor configured to providing a handle message comprising the handle to the second device, wherein
the second receiving processor is configured to receive the request for user interaction in response to the provision of the handle message.

68. The apparatus according to claim 67, further comprising:
an identifying processor configured to identify the second device based on the received retry message comprising the handle.

69. The apparatus according to claim 67, wherein
said response to said request for user interaction is configured to trigger a second sending of said service request to said first device.

70. The apparatus according to claim 67, further comprising
third receiving processor configured to receive the service request from said user interface.

71. A user interaction proxy comprising an apparatus according to claim 67.

72. A system, comprising:
a first resource apparatus according to claim 50; and
a user interaction apparatus, comprising a sending processor configured to send a service request to a first device, a first receiving processor configured to receive a request for user interaction from a second device in order to comply with said service request, wherein the second device is different from the first device, a requesting processor configured to request said user interaction from a user interaction device without having received a response to the service request for user interaction from the first device, a second receiving processor configured to receive said user interaction from said user interaction device, and a responding processor configured to respond, to said request for user interaction, based on said user interaction received from said user interaction device, wherein
the second party of the first resource apparatus comprises the user interaction apparatus;
the second device of the user interaction apparatus comprises the first resource apparatus;
the request for said user interaction of the first resource apparatus is the received request for user interaction of the user interaction apparatus; and
the response to said user request for user interaction of the user interaction apparatus is the user interaction received by the first resource apparatus.

73. A system, comprising
a first resource apparatus according to claim 50; and
a user interaction apparatus, comprising a sending processor configured to send a service request to a first device, a first receiving processor configured to receive a request for user interaction from a second device in order to comply with said service request, wherein the second device is different from the first device, a requesting processor configured to request said user interaction from a user interaction device, a second receiving processor configured to receive said user interaction from said user interaction device, a responding processor configured to respond, to said request for user interaction, based on said user interaction received from said user interaction device, a fourth receiving processor configured to receive a retry message comprising a handle in response to the service request, a handle message providing processor configured to providing a handle message comprising the handle to the second device, wherein the second receiving processor is configured to receive the request for user interaction in response to the provision of the handle message, and wherein
the second party of the first resource apparatus comprises the user interaction apparatus;
the second device of the user interaction apparatus comprises the first resource apparatus;
the request for said user interaction of the first resource apparatus is the received request for user interaction of the user interaction apparatus; and
the response to said user request for user interaction of the user interaction apparatus is the user interaction received by the first resource apparatus.

74. A method, comprising:
receiving a service request from a first party;
detecting a requirement for a first identification of the user in order to comply with said service request;
checking if any identification of the user is available at an apparatus performing the method;
requesting, if any identification of the user is not available, said first identification of the user from a second party different from the first party; and
receiving said first identification of the user as a response from said second party.

75. The method according to claim 74, wherein
said request for the first identification of the user comprises an information element for provisioning a user interface for executing said identification of the user.

76. The method according to claim 74, further comprising
requesting a second resource from a resource device in order to comply with said service request; and wherein
the detecting is adapted to detect the requirement for the first identification of the user based on an exception information received from the resource device in response to the request for the resource.

77. The method according to claim 74, wherein said request for the first identification of the user comprises an identification of said service request.

78. The method according to claim 74, wherein
the requesting is configured to provide, together with said request for said first identification of the user, a transaction identifier, wherein the transaction identifier is comprised in the service request received from the first party.

79. The method according to claim 74, further comprising:
responding to the first party, wherein the response comprises a trigger for terminating service execution, compliant to the service request, in the first party.

80. The method according to claim 74, further comprising:
generating a handle which is related to the service request received from the first party, and wherein the handle is unique in a realm of an apparatus performing the method;
detecting if a handle message comprising the handle is received by the apparatus from the second party; and wherein
the requesting is configured to request the first identification of the user if the handle message is detected.

81. The method according to claim 80, further comprising
identifying the second party based on the handle message.

82. A method, comprising:
sending a service request to a first device;
receiving a request for user interaction from a second device in order to comply with said service request, wherein the second device is different from the first device;
requesting said user interaction from a user interaction device without having received a response to the service request from the first device;
receiving said user interaction from said user interaction device; and
responding, to said request for user interaction, based on said user interaction received from said user interaction device.

83. The method according to claim 82, wherein
said service request comprises an identification of the device sending said service request.

84. The method according to claim 82, wherein
said request for user interaction comprises an identification of said service request.

85. The method according to claim 84, further comprising
generating an identifier for the service request, wherein said response to said request for user interaction comprises said identifier of said service request.

86. The method according to claim 85, further comprising:
receiving an error message in response to the service request;
correlating the error message with the request for user interaction based on said identifier.

87. The method according to claim 82, wherein
said response to said request for user interaction is configured to trigger a second sending of said service request to said first device.

88. The method according to claim 82, further comprising
receiving the service request from said user interface.

89. A method, comprising:
sending a service request to a first device;
receiving a retry message comprising a handle in response to the service request;
providing a handle message comprising the handle to a second device;
receiving, in response to the provision of the handle message, a request for user interaction from the second device in order to comply with said service request, wherein the second device is different from the first device;
requesting said user interaction from a user interaction device;
receiving said user interaction from said user interaction device;
responding, to said request for user interaction, based on said user interaction received from said user interaction device.

90. The method according to claim 89, further comprising
identifying the second device based on the received retry message comprising the handle.

91. The method according to claim 89, wherein
said response to said request for user interaction is configured to trigger a second sending of said service request to said first device.

92. The method according to claim 89, further comprising
receiving the service request from said user interface.

93. A computer program product stored on a non-transitory computer readable medium and including a program comprising software code portions being configured, when run on a processor of an apparatus, to perform the method according to claim 74.

94. A computer program product stored on a non-transitory computer readable medium and including a program comprising software code portions being configured, when run on a processor of an apparatus, to perform the method according to claim 82.

95. A computer program product stored on a non-transitory computer readable medium and including a program comprising software code portions being configured, when run on a processor of an apparatus, to perform the method according to claim 89.
